(19) United States
(12) Patent Application Publication
(10) Pub. No.: US 2026/0175484 A1
(43) Pub. Date: Jun. 25, 2026

(54) INSERT-MOLDED ARTICLE MANUFACTURING METHOD, INSERT-MOLDING DIE, AND INSERT-MOLDED ARTICLE

(71) Applicant: Yazaki Corporation, Tokyo (JP)

(72) Inventors: Kazuhiro TSUCHIDA, Shizuoka (JP); Tomohiro SHIBATA, Shizuoka (JP)

(73) Assignee: Yazaki Corporation, Tokyo (JP)

(21) Appl. No.: 19/419,320

(22) Filed: Dec. 15, 2025

(30) Foreign Application Priority Data
Dec. 24, 2024 (JP) 2024-226923

(51) Int. Cl. B29C 45/14; B29C 45/26

(52) U.S. Cl. CPC B29C 45/14262; B29C 45/2602

(57) ABSTRACT

An insert-molded article manufacturing method includes: an insert process of disposing a metal collar in a first die; and a clamping process of clamping a second die and the first die to press an opening edge (13a) of a cylindrical portion on a side of the second die from a side of an inner peripheral surface to an outer side by a pressing protrusion formed to project radially outward from an outer peripheral surface of an insertion portion and form a locking protrusion on an outer peripheral surface of the cylindrical portion corresponding to the opening edge.

### CROSS-REFERENCE TO RELATED APPLICATION(S)

The present application claims priority to and incorporates by reference the entire contents of Japanese Patent Application No. 2024-226923 filed in Japan on Dec. 24, 2024.

### BACKGROUND OF THE INVENTION

1. Field of the Invention

The present invention relates to an insert-molded article manufacturing method, an insert-molding die, and an insert-molded article.

2. Description of the Related Art

As a technique related to an insert-molded article manufacturing method, an insert-molding die, and an insert-molded article in the related art, Japanese Patent Application Laid-open No. 2004-42561, for example, discloses an insert-molded article manufacturing method including setting a collar made of a metal material and obtained by forming easily deformed portions at both end portions inside a molding die, then causing an upper die and a lower die to approach each other to crush the easily deformed portions, and performing molding in a state where flat surfaces obtained by the easily deformed portions being crushed are in close contact with the upper die or the lower die, an insert-molding die, and an insert-molded article.

Incidentally, such an insert-molded article manufacturing method, an insert-molding die, and an insert-molded article may be configured such that knurling is performed on the outer periphery of the metal collar, for example, to prevent the metal collar from easily coming off from a resin molded portion. There is room for further improvement in the configuration in which the metal collar is assembled with the resin molded portion.

### SUMMARY OF THE INVENTION

The present invention has been made in view of the above circumstances, and an object thereof is to provide an insert-molded article manufacturing method, an insert-molding die, and an insert-molded article enabling a metal collar to be appropriately assembled with a resin molded portion.

To achieve the objection, an insert-molded article manufacturing method according to one aspect of the present invention includes an insert process of disposing a metal collar including a tubular portion in a first die such that an axial center of the tubular portion follows a clamping direction; a clamping process of clamping a second die including a pillar-shaped insertion portion and the first die to insert the insertion portion from a side of the second die to a side of an inner peripheral surface of the tubular portion, pressing an opening edge of the tubular portion on the side of the second die from the side of the inner peripheral surface to the outer side by a pressing protrusion formed to project radially outward from an outer peripheral surface of the insertion portion, and forming a locking protrusion on an outer peripheral surface of the tubular portion corresponding to the opening edge; and a molding process of filling a cavity formed around the tubular portion by the first die and the second die clamped in the clamping process with a resin.

To achieve the objection, an insert-molding die according to another aspect of the present invention includes a first die that includes a metal collar support portion that supports a metal collar including a tubular portion; and a second die that includes an insertion portion inserted into the tubular portion of the metal collar and includes a pressing protrusion formed to project radially outward from an outer peripheral surface of the insertion portion to press an opening edge of the tubular portion from a side of an inner peripheral surface to an outer side, wherein the metal collar support portion of the first die includes a collar end surface support surface that abuts on an end surface of the metal collar on one side, and the second die includes an annular collar end surface abutting surface that is formed around a base portion of the insertion portion to abut on an end surface of the metal collar on the other side and a protrusion forming portion that includes a clearance space formed on a radially outer side of the collar end surface abutting surface and formed to be able to release an outer periphery of the pressed and deformed metal collar.

To achieve the objection, an insert-molded article according to another aspect of the present invention includes a metal collar that includes a tubular portion; and a resin molded portion with which the metal collar is assembled, wherein the tubular portion is provided with an inclined edge portion that is formed to expand from an inner peripheral surface to an opening edge of the tubular portion and a locking protrusion that projects radially outward from an outer peripheral surface of the tubular portion and bites into and locks the resin molded portion, and an end surface of the tubular portion to which the opening edge provided with the inclined edge portion is connected is formed in a flat surface shape.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an insert-molded article according to an embodiment;

FIG. 2 is a perspective view illustrating the insert-molded article according to the embodiment;

FIG. 3 is a sectional view along III-III in FIG. 1;

FIG. 4 is a sectional view along IV-IV in FIG. 1;

FIG. 5 is a perspective view illustrating a metal collar assembled with the insert-molded article according to the embodiment;

FIG. 6 is a sectional view corresponding to the section along III-III in FIG. 1 illustrating a state where a first die and a second die of an insert-molding die according to the embodiment are spaced apart from each other and the metal collar is arranged in the first die;

FIG. 7 is a perspective view illustrating a metal collar support portion of the first die according to the embodiment;

FIG. 8 is a perspective view illustrating an insert member of the second die according to the embodiment;

FIG. 9 is an enlarged sectional view of a portion P1 in FIG. 6;

FIG. 10 is a perspective view illustrating an insertion portion forming recessed portion and the insert member of the second die according to the embodiment;

FIG. 11 is a flowchart illustrating an insert-molded article manufacturing method according to the embodiment;

FIG. 12 is a sectional view corresponding to the section along III-III in FIG. 1 illustrating a state where the insert-molding die according to the embodiment is clamped and a cavity is filled with a resin;

FIG. 13 is a sectional view corresponding to the section along IV-IV in FIG. 1 illustrating a state where the insert-molding die according to the embodiment is clamped and the cavity is filled with a resin;

FIG. 14 is an enlarged sectional view of a portion P2 in FIG. 12;

FIG. 15 is an enlarged sectional view of a portion P3 in FIG. 13;

FIG. 16 is a perspective view illustrating a metal collar assembled with an insert-molded article according to a modification of the embodiment;

FIG. 17 is a perspective view illustrating an insert member of a second die according to the modification of the embodiment; and

FIG. 18 is a perspective view illustrating an insertion portion forming recessed portion and an insert member of the second die according to the embodiment.

### DETAILED DESCRIPTION OF THE PREFERRED EMBODIMENTS

Hereinafter, an embodiment according to the present invention will be described in detail on the basis of the drawings. Note that the present invention is not limited by the embodiment. In addition, constituent elements in the following embodiments include those that can be easily replaced by those skilled in the art or those that are substantially the same as such elements.

### Embodiment

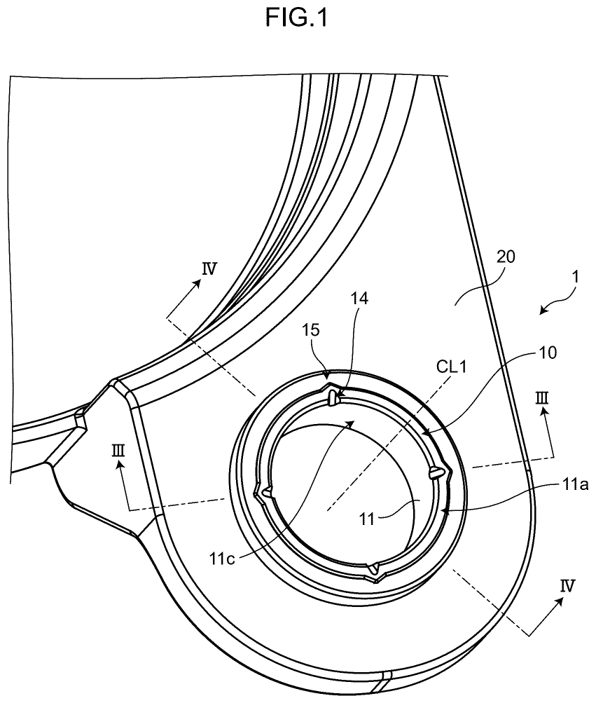

An insert-molded article 1 according to the present embodiment illustrated in FIGS. 1 to 4 can be a protector assembled in a wire harness routed in a vehicle such as an automobile, for example. Here, the wire harness is configured such that a plurality of wiring materials used for power supply and signal communication are bundled to form a collective component for connection among devices mounted in the vehicle and the plurality of wiring materials are connected to the devices with connectors or the like, for example. The wiring materials are, for example, insulated wires in which core wires obtained by bundling a plurality of conductive metal element wires are covered with insulating covering portions. The wiring materials may be obtained by bundling a plurality of insulated wires. The protector that is the insert-molded article 1 is adapted to protect the wiring materials routed therein, is fixed to the vehicle, and regulates routing paths of the wiring materials.

The protector as the insert-molded article 1 includes a metal collar 10 and a resin molded portion 20 serving as a protector main body with which the metal collar 10 is assembled. The metal collar 10 is made of, for example, a conductive metal material and is formed in a substantially cylindrical shape around an axial center CL1. The metal collar 10 includes a cylindrical portion 11 (tubular portion) formed in substantially a cylindrical shape and a flange portion 12 formed at an end portion of the cylindrical portion 11 on one side in the direction of the axial center CL1.

Note that the following description will be given on the assumption that the one side of the metal collar 10 in the direction of the axial center CL1 is a lower side while the other side is an upper side.

Although not illustrated, for example, the insert-molded article 1 is fixed to the body of the vehicle or the like along with an earth terminal with a round terminal of the earth terminal in contact with an upper end surface 11a of the cylindrical portion 11 of the metal collar 10, with a lower end surface 11b (a lower surface 12b of the flange portion 12) in contact with the body of the vehicle or the like, and with a bolt inserted into the cylindrical portion 11. In this manner, the earth terminal is electrically connected to the body of the vehicle or the like via the metal collar 10. The end surface 11a and the end surface 11b (the lower surface 12b of the flange portion 12) of the cylindrical portion 11 are formed in a flat surface shape.

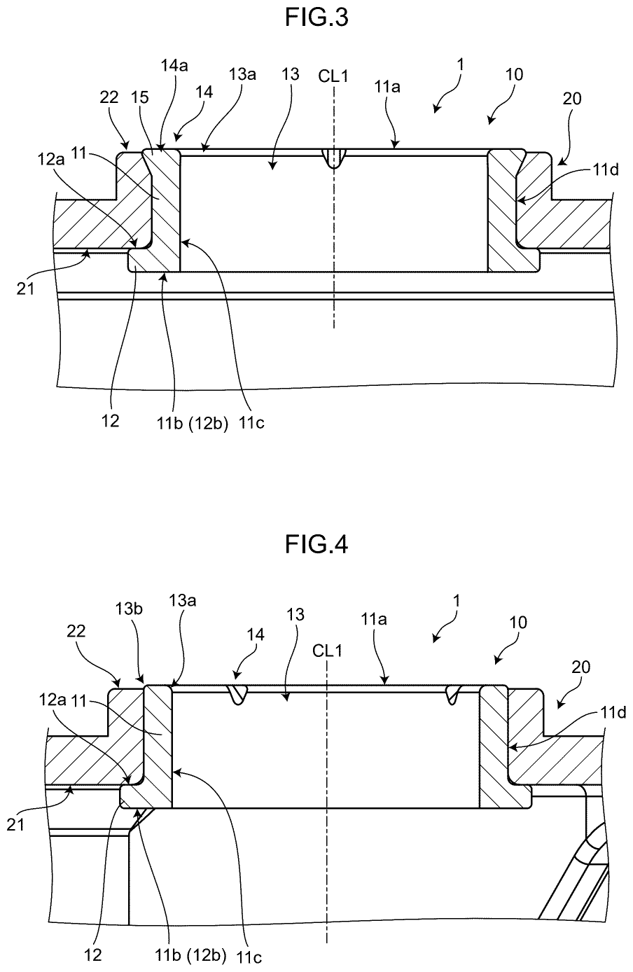

As illustrated in FIGS. 3 and 4, an opening edge 13a of an upper opening 13 in the cylindrical portion 11 of the metal collar 10 and an outer peripheral surface 11d of the cylindrical portion 11 corresponding to the opening edge 13a connect to the end surface 11a of the cylindrical portion 11 and are round-chamfered. The opening edge 13a of the cylindrical portion 11 is provided with recessed portions 14 that are formed in a recessed shape from an inner peripheral surface 11c of the cylindrical portion 11. The outer peripheral surface 11d of the cylindrical portion 11 corresponding to the opening edge 13a is provided with locking protrusions 15 projecting radially outward from the outer peripheral surface 11d including an outer edge 13b. A recessed portion 14 and a locking protrusion 15 are provided as a pair to face each other in the radial direction of the cylindrical portion 11. Plurality of numbers of, namely four recessed portions 14 and four locking protrusions 15 are provided at equal intervals in the circumferential direction around the axial center CL1.

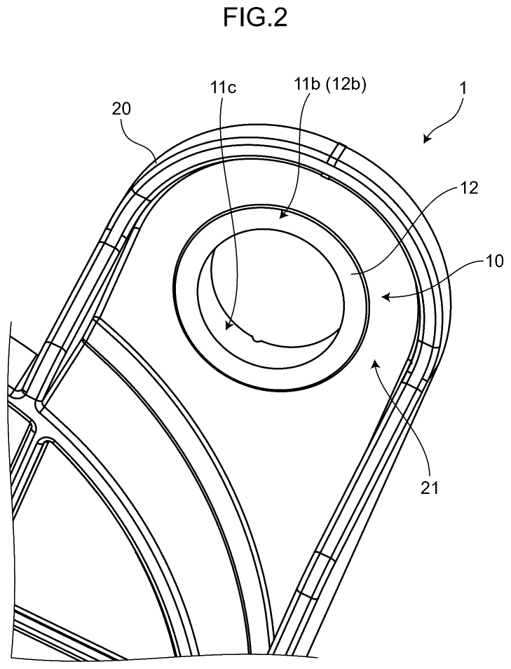

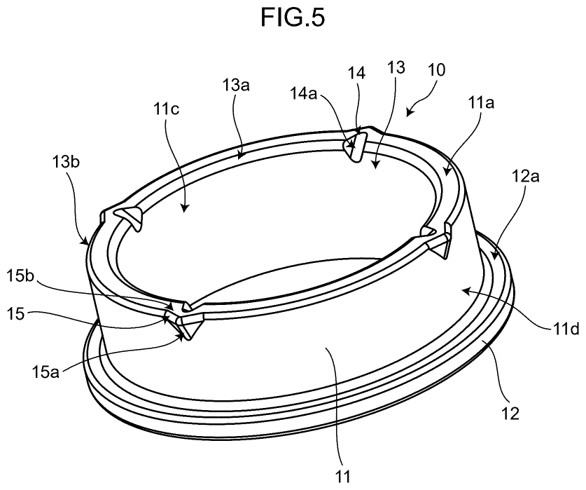

As illustrated in FIGS. 3 and 5, the recessed portions 14 have inclined edge portions 14a formed to expand from the inner peripheral surface 11c of the cylindrical portion 11. The locking protrusions 15 are formed in a substantially conical shape with a vertex directed downward such that the locking protrusions 15 expand from the lower side toward the upper side. A bottom surface part 15b of the substantially conical shape of each locking protrusion 15 is formed in a flat surface shape in the same plane that is continuous with the end surface 11a of the cylindrical portion 11. As illustrated in FIGS. 1 and 3, the metal collar 10 is locked with the locking protrusions 15 biting into the resin molded portion 20. This prevents the metal collar 10 from coming off in the downward direction. As illustrated in FIGS. 2 and 4, an upper surface 12a of the flange portion 12 of the metal collar 10 abuts on a lower surface 21 of the resin molded portion 20. This prevents the metal collar 10 from coming off in the upward direction.

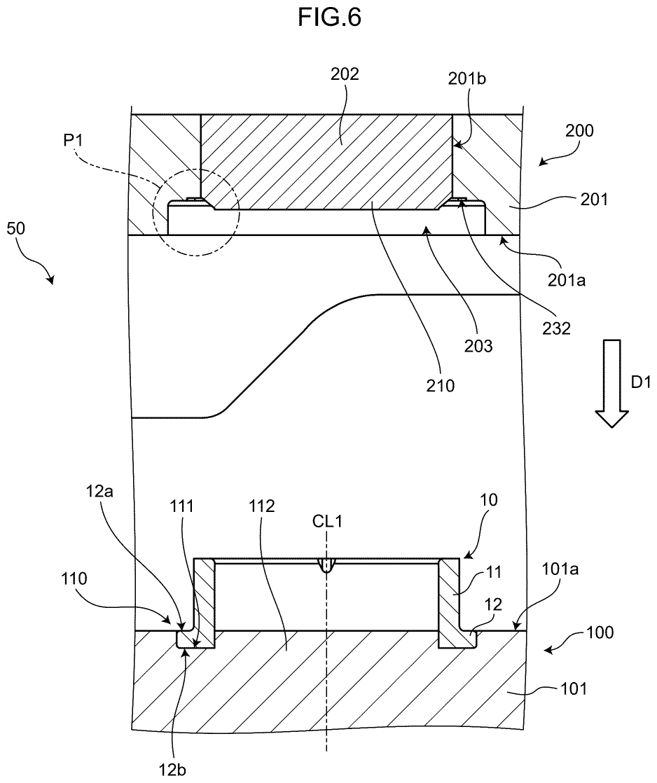

As illustrated in FIG. 6, an insert-molding die 50 for manufacturing the insert-molded article 1 includes a first die 100 and a second die 200. In the insert-molding die 50, the first die 100 can be disposed on the lower fixed side of a vertical injection molding apparatus, and the second die 200 can be disposed on the upper movable side, for example. The first die 100 and the second die 200 are clamped such that they relatively approach each other, and are opened such that they are relatively spaced apart from each other. Specifically, as illustrated in a clamping direction D1, the second die 200 is moved from the upper side to the lower side to be clamped, and is moved to the side opposite to the clamping direction D1, that is, from the lower side to the upper side to be opened.

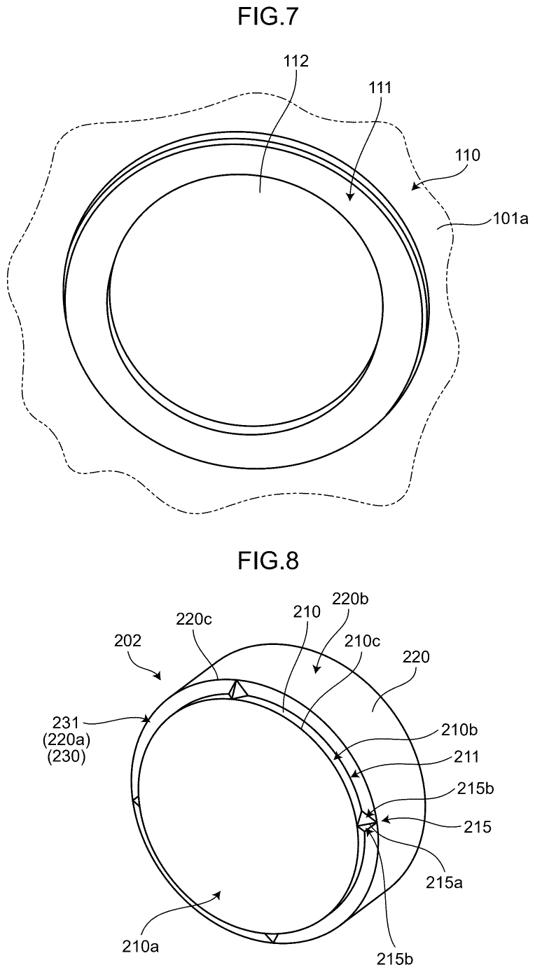

The first die 100 includes a first die body 101 and a metal collar support portion 110 provided on the first die body 101. The upper surface of the first die body 101 is formed in a flat surface shape and is a cavity surface 101a. The metal collar support portion 110, an insertion portion forming recessed portion 203 of the second die 200, which will be described later, and an insert member 202 are concentrically disposed. The metal collar support portion 110 supports the metal collar 10 including the cylindrical portion 11. The metal collar support portion 110 is provided on the cavity surface 101a of the first die body 101. Specifically, as illustrated in FIG. 7, the metal collar support portion 110 has a collar end surface support surface 111 that abuts on a lower end surface 11b (a lower surface 12b of the flange portion 12) of the cylindrical portion 11 of the metal collar 10. The collar end surface support surface 111 is formed as a bottom surface of an annular recessed groove. A collar support column 112 formed in a thin columnar shape is formed inside the collar end surface support surface 111. The collar support column 112 is inserted into the cylindrical portion 11 from the lower side of the metal collar 10. The metal collar support portion 110 restricts movement of the metal collar 10 in a horizontal direction with the cavity surface 101a. As illustrated in FIG. 6, the distance from the cavity surface 101a to the collar end surface support surface 111 (that is, the depth of the collar end surface support surface 111) is equal to the thickness of the flange portion 12 of the metal collar 10.

As illustrated in FIG. 6, the second die 200 includes a second die body 201 and the insert member 202 detachably provided in the second die body 201. The insert member 202 includes an insertion portion 210 inserted into the cylindrical portion 11 of the metal collar 10. More specifically, as illustrated in FIG. 8, the insert member 202 includes an insert member body 220 that is formed in a substantially columnar shape, which is a pillar shape. The insert member body 220 is formed in a substantially columnar shape. The insertion portion 210 is formed in a thin substantially columnar shape protruding from a lower surface 220a of the insert member body 220 on one side (lower side). The insertion portion 210 is formed to have a thickness in the up-down direction that is sufficiently thinner than the thickness of the insert member body 220 in the up-down direction. The axial center of the insertion portion 210 is concentric with the axial center of the insert member body 220. The diameter of the insertion portion 210 is smaller than the diameter of the insert member body 220. Therefore, the lower surface 220a of the insert member 202 is annularly exposed around a base portion 211 of the insertion portion 210. A part of the lower surface 220a exposed in an annular shape is an insert member-side collar end surface abutting surface 231.

The insert member 202 is provided with a pressing protrusion 215 formed to project radially outward from an outer peripheral surface 210b of the insertion portion 210. The pressing protrusion 215 is formed in a substantially triangular pyramid shape. The pressing protrusion 215 having a substantially triangular pyramid shape has one surface connected to the insert member-side collar end surface abutting surface 231 and the other surface connected to the outer peripheral surface 210b of the insertion portion 210.

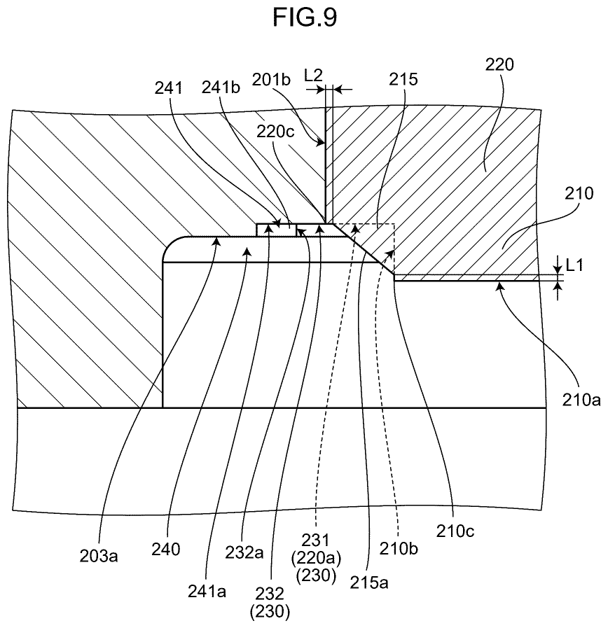

The pressing protrusion 215 has a tapered portion 215a that is inclined in a direction in which the diameter expands from a distal end side (lower side) of the insertion portion 210. In the present embodiment, the tapered portion 215a is one side of the pressing protrusion 215 formed in a substantially triangular pyramid shape. Therefore, two side surfaces 215b are provided on both sides of the tapered portion 215a in the circumferential direction of the insertion portion 210. More specifically, as illustrated in FIG. 9, the lower end of the tapered portion 215a (that is, one vertex of the pressing protrusion 215 having a substantially triangular pyramid shape) is connected to the outer peripheral surface 210b on the upper side from an edge 210c of a distal end surface 210a of the insertion portion 210 by a predetermined distance L1. In addition, the upper end of the tapered portion 215a (that is, another vertex portion of the pressing protrusion 215 having a substantially triangular pyramid shape) is connected to the insert member-side collar end surface abutting surface 231 on the inner side from an edge 220c of an outer peripheral surface 220b of the insert member body 220 by a distance L2 on the radially inner side.

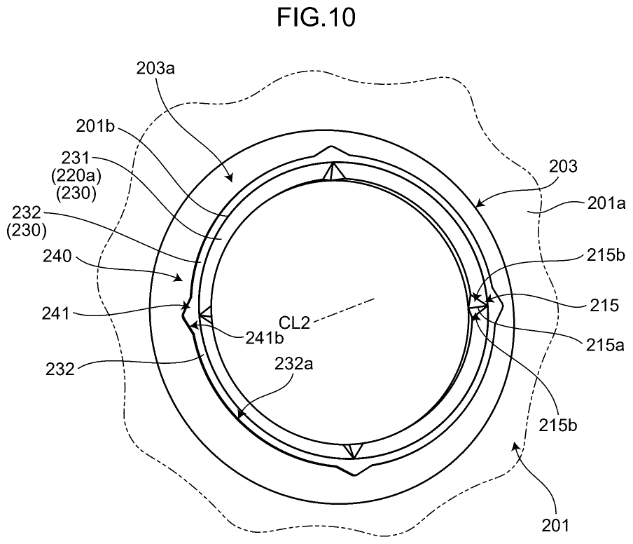

Returning to FIG. 6, the lower surface of the second die body 201 is formed in a flat surface shape and is a cavity surface 201a. The second die body 201 is provided with an attachment hole 201b penetrating in a circular shape so that the insert member 202 is assembled therewith. The insert member 202 is detachably assembled with the attachment hole 201b. As illustrated in FIGS. 6 and 10, a circular insertion portion forming recessed portion 203 formed in a recessed shape from the cavity surface 201a is provided below the attachment hole 201b. The insertion portion forming recessed portion 203 is disposed concentrically with the attachment hole 201b. The insertion portion forming recessed portion 203 is formed to have a diameter that is larger than that of the attachment hole 201b.

In the insertion portion forming recessed portion 203, an annular body-side collar end surface abutting surface 232 is formed on the side further radially outward than the insert member-side collar end surface abutting surface 231 of the insert member 202. As illustrated in FIGS. 9 and 10, the body-side collar end surface abutting surface 232 is formed in a flat surface shape in the same plane that is continuous with the insert member-side collar end surface abutting surface 231. In the second die 200, the insert member-side collar end surface abutting surface 231 and the body-side collar end surface abutting surface 232 constitute a collar end surface abutting surface 230. In other words, the collar end surface abutting surface 230 is formed over the insert member-side collar end surface abutting surface 231 and the body-side collar end surface abutting surface 232.

As illustrated in FIGS. 9 and 10, an annular cavity surface 203a is formed on the radially outer side of the collar end surface abutting surface 230 in the insertion portion forming recessed portion 203. The annular cavity surface 203a is connected to a peripheral wall surface 232a formed in a substantially annular wall shape on the radially outer side of the body-side collar end surface abutting surface 232 (collar end surface abutting surface 230). In other words, the peripheral wall surface 232a that is formed in an annular wall shape standing from the body-side collar end surface abutting surface 232 and is connected to the annular cavity surface 203a is formed on the radially outer side of the body-side collar end surface abutting surface 232.

The annular cavity surface 203a is provided with a plurality of, namely four protrusion forming portions 240. Each protrusion forming portion 240 is provided with a clearance space 241 formed by being recessed upward in a substantially triangular shape from the annular cavity surface 203a. A bottom surface 241a of the clearance space 241 is formed in a flat surface shape in the same plane that is continuous with the collar end surface abutting surface 230 (body-side collar end surface abutting surface 232). The clearance space 241 is provided with the vertex of the substantially triangular shape directed radially outward. A peripheral wall surface 241b formed continuously from the peripheral wall surface 232a is formed around the clearance space 241 on the radially outer side.

The protrusion forming portion 240 is provided corresponding to the pressing protrusion 215 of the insert member 202 assembled with the attachment hole 201b. In other words, a set of the protrusion forming portion 240 and the pressing protrusion 215 are located at the same position around the axial center CL2 of the insert member 202.

Each of the first die 100 and the second die 200 has a parting surface, which is not illustrated. The first die 100 and the second die 200 are clamped by being caused to relatively approach each other such that the parting surfaces thereof are caused to abut on each other. A cavity 250, which is a blocked space formed by the cavity surface 101a of the first die 100, the cavity surface 201a (annular cavity surface 203a) of the second die 200, and the like is formed by the first die 100 and the second die 200 being clamped (see FIG. 12).

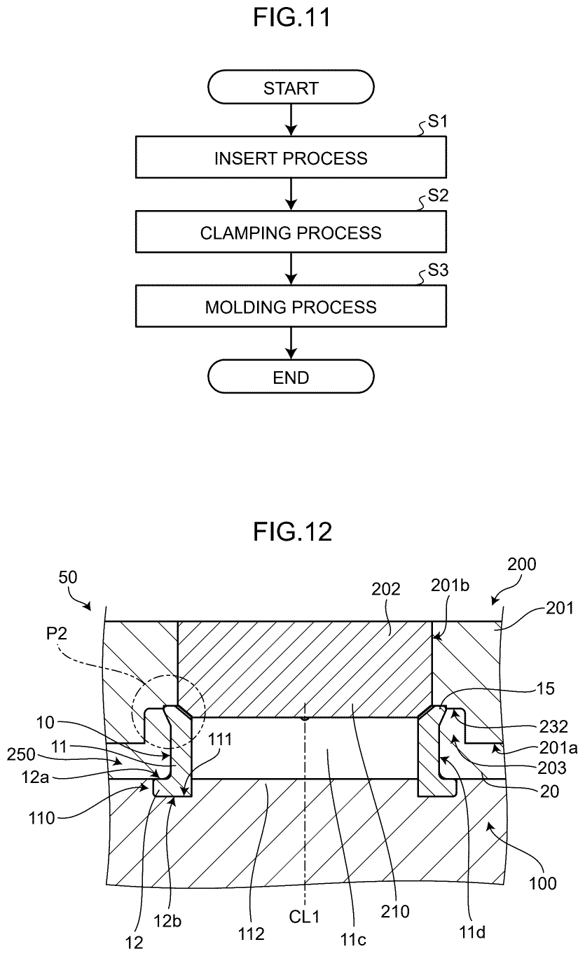

As illustrated in FIG. 11, an insert-molded article manufacturing method for manufacturing the insert-molded article 1 using the insert-molding die 50 includes an insert process (Step S1), a clamping process (Step S2), and a molding process (Step S3).

Insert process (Step S1); As illustrated in FIG. 6, the insert-molding die 50 is opened, and the metal collar 10 is disposed at the first die 100 such that the axial center CL1 of the cylindrical portion 11 follows the clamping direction D1 in the insert process (Step S1). Specifically, the metal collar 10 is disposed at the metal collar support portion 110 of the first die 100 with the flange portion 12 directed to the first die 100. At this time, the lower surface 12b of the flange portion 12 is caused to abut on the collar end surface support surface 111 of the metal collar support portion 110, and the collar support column 112 is inserted into the inner peripheral surface 11c of the cylindrical portion 11 of the metal collar 10. The upper surface 12a of the flange portion 12 of the metal collar 10 is disposed such that the upper surface 12a is substantially continuous with the cavity surface 101a of the first die 100.

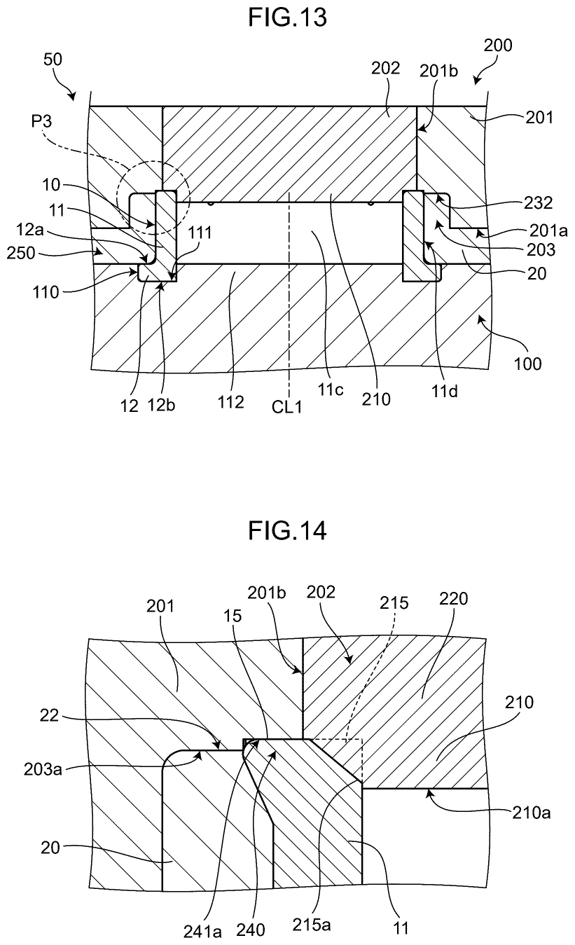

Clamping process (Step S2); In the clamping process (Step S2), the second die 200 is moved in the clamping direction D1, and the first die 100 and the second die 200 are clamped as illustrated in FIGS. 12 and 13 after the insert process (Step S1). The insertion portion 210 of the second die 200 is inserted on the side of the inner peripheral surface 11c of the cylindrical portion 11 of the metal collar 10 by the first die 100 and the second die 200 being clamped. Then, the opening edge 13a of the cylindrical portion 11 on the side of the second die 200 is pressed outward from the side of the inner peripheral surface 11c by the pressing protrusion 215 of the insertion portion 210. Then, the locking protrusions 15 are formed on the outer peripheral surface 11d of the cylindrical portion 11 corresponding to the opening edge 13a. In other words, the locking protrusion 15 is formed to project radially outward from the outer edge 13b of the outer peripheral surface 11d.

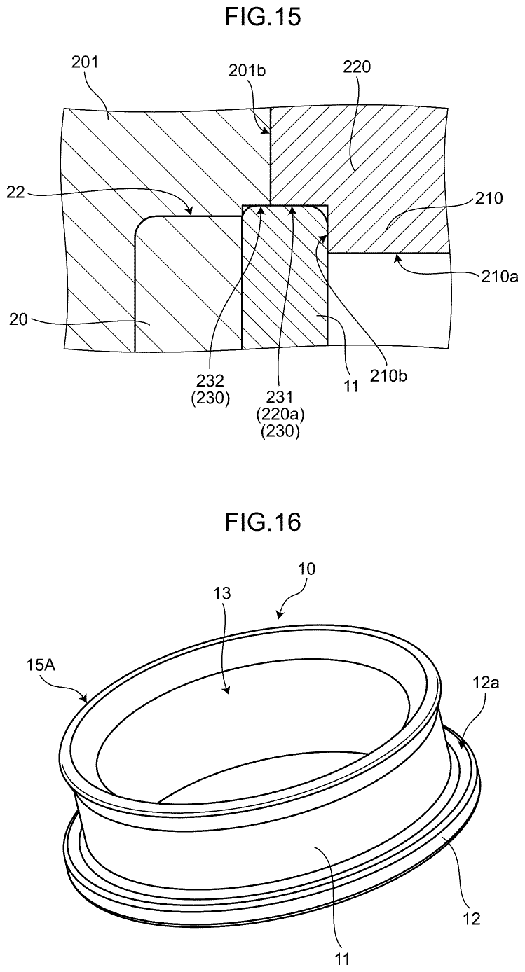

More specifically, as illustrated in FIGS. 14 and 15, the collar end surface abutting surface 230 is caused to abut on the end surface 11a of the cylindrical portion 11 when the first die 100 and the second die 200 are clamped in the clamping process (Step S2). In the clamping process (Step S2), the peripheral wall surface 232a is brought into a sliding contact with the outer peripheral surface 11d (outer edge 13b) of the cylindrical portion 11. In the clamping process (Step S2), the locking protrusions 15 are formed by releasing the outer periphery of the pressed and deformed cylindrical portion 11 to the clearance space 241 of the protrusion forming portion 240 when the pressing protrusion 215 presses the opening edge 13a outward from the side of the inner peripheral surface 11c. The outer periphery of the pressed and deformed cylindrical portion 11, which has entered the clearance space 241 of the protrusion forming portion 240, is caused to serve as a bottom surface part 15b of each locking protrusion 15 in a flat surface shape that is continuous with the end surface 11a by the bottom surface 241a of the clearance space 241, and is shaped in a substantially triangular shape in a top view by the peripheral wall surface 241b. In this manner, the locking protrusions 15 are formed in the manner of press molding.

Here, the annular cavity surface 203a of the insertion portion forming recessed portion 203 of the second die 200 is located on a slightly lower side than the bottom surface part 15b of each locking protrusion 15 and the end surface 11a of the cylindrical portion 11 when the first die 100 and the second die 200 are clamped. In this manner, the upper end surface 22 (see FIGS. 3 and 4) of the resin molded portion 20 around the cylindrical portion 11 is located on a slightly lower side than the end surface 11a, and it is possible to reliably reduce covering of the end surface 11a with a resin. Note that the annular cavity surface 203a can also be formed in the same plane as the end surface 11a (that is, in the same plane that is continuous with the collar end surface abutting surface 230). In the present embodiment, a plurality of, namely four pressing protrusions 215 are provided at equal intervals such that the pressing protrusions 215 are spaced apart from each other in the circumferential direction of the insertion portion 210. Therefore, the four locking protrusions 15 are formed at equal intervals in the circumferential direction of the cylindrical portion 11 in the clamping process (Step S2).

In the present embodiment, the collar end surface abutting surface 230 is formed over the insert member-side collar end surface abutting surface 231 and the body-side collar end surface abutting surface 232. Therefore, in the clamping process (Step S2), each of the insert member-side collar end surface abutting surface 231 and the body-side collar end surface abutting surface 232 abuts on the end surface 11a of the cylindrical portion 11, and the pressing protrusion 215 of the insert member 202 is positioned in the up-down direction by the abutting between the insert member-side collar end surface abutting surface 231 and the end surface 11a. In this manner, the locking protrusions 15 having a predetermined shape can be stably formed regardless of a dimensional error of the metal collar 10 (particularly, the dimensional error of the length of the cylindrical portion 11 in the up-down direction).

In the clamping process (Step S2), the cavity 250 is formed by the first die 100 and the second die 200 being clamped. The cavity 250 is formed around the cylindrical portion 11 of the metal collar 10.

Molding process (Step S3); As illustrated in FIGS. 12 and 13, the cavity 250 formed by the insert-molding die 50 being clamped in the clamping process (Step S2) is filled with a resin in the molding process (Step S3).

After completion of the molding process (Step S3), the second die 200 is moved upward to open the first die 100 and the second die 200, and the molded insert-molded article 1 is taken out of the first die 100. It is thus possible to obtain the insert-molded article 1 by the insert-molded article manufacturing method using the insert-molding die 50.

### Modifications

Next, modifications of the present embodiment will be described with reference to FIGS. 16 to 18. In the present modification, the metal collar 10 includes a locking protrusion 15A formed in an annular shape on the outer peripheral surface 11d as illustrated in FIG. 16 instead of the plurality of locking protrusions 15 formed in the circumferential direction of the outer peripheral surface 11d of the metal collar 10 illustrated in FIG. 5 and the like. The locking protrusion 15A is formed to have a sectional shape that is similar to that of the locking protrusions 15 illustrated in FIG. 3.

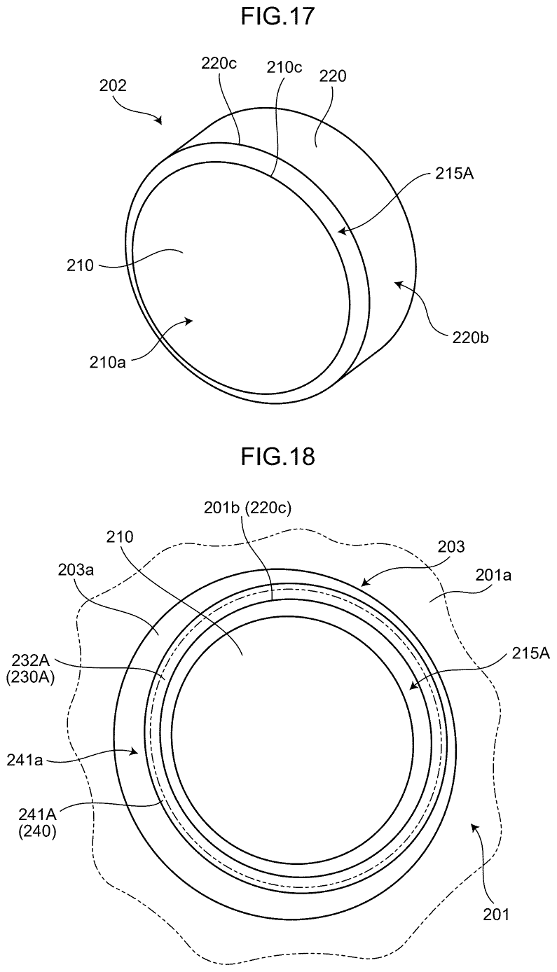

In order to form the annular locking protrusion 15A, a pressing protrusion 215A formed in an annular shape on the outer peripheral surface 210b of the insertion portion 210 is adopted instead of the plurality of pressing protrusions 215 in the present embodiment, as illustrated in FIG. 17, for the insert member 202. The tapered portion 215Aa of the pressing protrusion 215A in this modification is an annular inclined surface that is inclined in a direction in which the diameter expands from the distal end side of the insertion portion 210. In the clamping process (Step S2), the annular locking protrusion 15A is formed by the pressing protrusion 215A.

On the other hand, the insertion portion forming recessed portion 203 of the second die 200 is obtained by forming a clearance space 241A that the protrusion forming portion 240 has in an annular shape. In the radial direction, an annular collar end surface abutting surface 230A is formed between the insert member 202 (edge 220c) and the bottom surface 241Aa of the clearance space 241A. The collar end surface abutting surface 230A in this modification is constituted only by a body-side collar end surface abutting surface 232A.

The insert-molded article manufacturing method described above includes: the insert process (Step S1) of disposing the metal collar 10 including the cylindrical portion 11 as a tubular portion in the first die 100 such that the axial center CL1 of the cylindrical portion 11 follows the clamping direction D1; the clamping process (Step S2) of clamping the second die 200 including the insertion portion 210 with the columnar shape, which is a pillar shape, and the first die 100 to insert the insertion portion 210 from the side of the second die 200 to the side of the inner peripheral surface 11c of the cylindrical portion 11, pressing the opening edge 13a of the cylindrical portion 11 on the side of the second die 200 from the side of the inner peripheral surface 11c to the outer side by the pressing protrusions 215 and 215A formed to project radially outward from the outer peripheral surface 210b of the insertion portion 210, and forming the locking protrusions 15 and 15A on the outer peripheral surface 11d of the cylindrical portion 11 corresponding to the opening edge 13a; and the molding process (Step S3) of filling the cavity 250 formed around the cylindrical portion 11 by the first die 100 and the second die 200 clamped in the clamping process (Step S2) with a resin.

In this manner, the metal collar 10 in the insert-molded article 1 can form the locking protrusions 15 and 15A projecting in the radial direction through the clamping between the first die 100 and the second die 200. Then, the locking protrusions 15 and 15A bite into the resin molded portion 20. Therefore, the metal collar 10 is prevented from coming off in the up-down direction (the downward direction in the present embodiment). Therefore, even if the metal collar 10 is fastened to a vehicle body along with an earth terminal with a bolt by using the insert-molded article 1 as a protector provided at a wire harness mounted in the vehicle, for example, it is possible to reduce the metal collar 10 easily dropping off from the resin molded portion 20 due to vibration and the like at the time of fastening the bolt or when the vehicle travels. Thus, according to the insert-molded article manufacturing method, it is possible to appropriately assemble the metal collar 10 with the resin molded portion 20.

In other words, according to the present embodiment, even if insert molding for assembling a metal collar in a known form including the cylindrical portion 11 and the flange portion 12, for example, with the resin molded portion 20 is performed, it is possible to obtain the insert-molded article 1 adapted to prevent the metal collar 10 from coming off from the resin molded portion 20. Therefore, there is no need to separately perform working such as knurling on the metal collar.

In addition, the plurality of the pressing protrusions 215 are provided at intervals in the circumferential direction of the insertion portion 210, and the plurality of locking protrusions 15 are formed by the plurality of pressing protrusions 215 in the clamping process (Step S2). In this manner, it is possible to form the locking protrusions 15 with a relatively small pressing force and to thereby manufacture the insert-molded article 1 using a small-sized injection molding machine with small energy consumption, for example.

Also, the pressing protrusion 215A is formed in an annular shape, and the annular locking protrusion 15A is formed by the pressing protrusion 215A in the clamping process (Step S2). In this manner, it is possible to cause the entire circumference of the cylindrical portion 11 of the metal collar 10 to bite into the resin molded portion 20, and even the metal collar 10 with a large size provided in the insert-molded article 1 with a large size can enhance a force of adhesion to the resin molded portion 20.

In addition, the pressing protrusions 215 and 215A have the tapered portions 215a and 215Aa inclined in the direction in which the diameters expand from the distal end side of the insertion portion 210, and the tapered portions 215a and 215Aa abut on the opening edge 13a and press the opening edge 13a from the side of the inner peripheral surface 11c to the outer side in the clamping process (Step S2). In this manner, it is possible to gradually press and deform the opening edge 13a while lowering the second die 200 to form the locking protrusions 15 and 15A and thereby to reduce occurrence of breaking, cracking, and the like of the metal collar 10 at the time of pressing and deforming of the locking protrusions 15 and 15A.

Also, the metal collar 10 includes the flange portion 12 formed at the outer periphery of the cylindrical portion 11, and the metal collar 10 is disposed with the flange portion 12 directed to the side of the first die 100 in the insert process (Step S1). In this manner, it is possible to use the flange portion 12 for preventing the metal collar 10 incorporated in the resin molded portion 20 from coming off on one side, and it is only necessary to form the locking protrusions 15 and 15A only on one side or the other side of the metal collar 10 in the up-down direction.

In addition, the second die 200 includes the annular collar end surface abutting surfaces 230 and 230A formed around the base portion 211 of the insertion portion 210 and the protrusion forming portion 240 including the clearance space 241 formed on the radially outer side of the collar end surface abutting surfaces 230 and 230A, and in the clamping process (Step S2), the collar end surface abutting surfaces 230 and 230A are caused to abut on the end surface 11a of the metal collar 10, the pressing protrusions 215 and 215A press the opening edge 13a from the side of the inner peripheral surface 11c to the outer side, and the outer periphery of the pressed and deformed metal collar 10 is released to the clearance space 241 of the protrusion forming portion 240, thereby forming the locking protrusions 15 and 15A. In this manner, it is possible to form the end surface 11a of the metal collar 10 in a flat surface shape, to prevent the end surface 11a from being covered with a resin even at the time of filling with the resin in the molding process (Step S3), and to thereby bring the earth terminal into close contact with the end surface 11a of the metal collar 10 at the time of fastening with the earth terminal by a bolt, for example.

Furthermore, the insert-molding die 50 includes: the first die 100 including the metal collar support portion 110 that supports the metal collar 10 including the cylindrical portion 11; and the second die 200 including the insertion portion 210 inserted into the cylindrical portion 11 of the metal collar 10 and including the pressing protrusions 215 and 215A formed to protrude radially outward from the outer peripheral surface 210b of the insertion portion 210 so as to press the opening edge 13a of the cylindrical portion 11 from the side of the inner peripheral surface 11c to the outer side, the metal collar support portion 110 of the first die 100 includes the collar end surface support surface 111 that abuts on the end surface 11b of the metal collar 10 on the lower side, which is the one side, and the second die 200 includes the annular collar end surface abutting surfaces 230 and 230A formed around the base portion 211 of the insertion portion 210 so as to abut on the end surface 11a of the metal collar 10 on the other side and the protrusion forming portion 240 including the clearance space 241 that is formed on the radially outer side of the collar end surface abutting surfaces 230 and 230A and is formed to be able to release the outer periphery of the pressed and deformed metal collar 10.

According to the insert-molding die 50, it is possible to appropriately assemble the metal collar 10 with the resin molded portion 20 by performing insert-molding with the insert-molding die 50 set in a molding apparatus such as an injection molding apparatus.

In addition, the second die 200 includes the second die body 201 constituting the cavity 250 formed around the cylindrical portion 11 and the insert member 202 provided with the insertion portion 210 and assembled with the second die body 201. In this manner, even in a case where the pressing protrusions 215 and 215A are worn out, it is only necessary to replace the insert member 202 with a new one, and there is thus no need to newly produce the entire second die 200.

In addition, the collar end surface abutting surfaces 230 and 230A are formed over the insert member-side collar end surface abutting surface 231 formed on the insert member 202 and the body-side collar end surface abutting surface 232 formed on the second die body 201. In this manner, it is possible to position the insert member 202 in the clamping direction D1 relative to the metal collar 10 and to thereby satisfactorily form the locking protrusions 15 and 15A while achieving stable pressing and deforming of the metal collar 10 by the pressing protrusions 215 and 215A.

Also, the insert-molded article 1 includes the metal collar 10 that includes the cylindrical portion 11 and the resin molded portion 20 with which the metal collar 10 is assembled, the cylindrical portion 11 is provided with the inclined edge portion 14a formed to expand from the inner peripheral surface 11c to the opening edge 13a of the cylindrical portion 11 and the locking protrusions 15 and 15A that project radially outward from the outer peripheral surface 11d of the cylindrical portion 11 and bite into and lock the resin molded portion 20, and the end surface 11a of the cylindrical portion 11 to which the opening edge 13a provided with the inclined edge portion 14a is connected is formed in a flat surface shape. It is thus possible to appropriately assemble the metal collar 10 with the resin molded portion 20 in the insert-molded article 1 with which the metal collar 10 is assembled.

Note that the insert-molded article manufacturing method, the insert-molding die, and the insert-molded article according to the embodiment of the present invention described above are not limited to the above-described embodiment, and various modifications can be made within the scope as claimed in the claims.

Although the metal collar 10 is provided with the flange portion 12 in the above description, it is also possible to use a metal collar with no flange portion 12 (that is, including only the cylindrical portion 11). In this case, the locking protrusion can be formed on each of the one side and the other side of the cylindrical portion, and the insert-molding die can be provided with the pressing protrusions 215 and 215A in both the first die and the second die. Furthermore, although the insertion portion 210 and the pressing protrusions 215 and 215A of the second die 200 are provided in the insert member 202 in the present embodiment and the insert member 202 is configured to be attached to the second die body 201, the insertion portion 210 and the pressing protrusions 215 and 215A may be provided directly in the second die body 201 without intervention of the insert member 202. Also, although the metal collar 10 is formed in a substantially cylindrical shape and includes the cylindrical portion 11 in the present embodiment, it is also possible to adopt a metal collar 10 formed in a substantially tubular shape, such as a substantially quadrangular prism shape, for example.

The insert-molded article manufacturing method, the insert-molding die, and the insert-molded article according to the present embodiment may be configured by appropriately combining components in the embodiment and the modifications described above.

The insert-molded article manufacturing method, an insert-molding die, and an insert-molded article according to the present embodiment have an effect that it is possible to appropriately assemble a metal collar with a resin molded portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An insert-molded article manufacturing method comprising:
an insert process of disposing a metal collar including a tubular portion in a first die such that an axial center of the tubular portion follows a clamping direction;
a clamping process of clamping a second die including a pillar-shaped insertion portion and the first die to insert the insertion portion from a side of the second die to a side of an inner peripheral surface of the tubular portion, pressing an opening edge of the tubular portion on the side of the second die from the side of the inner peripheral surface to the outer side by a pressing protrusion formed to project radially outward from an outer peripheral surface of the insertion portion, and forming a locking protrusion on an outer peripheral surface of the tubular portion corresponding to the opening edge; and
a molding process of filling a cavity formed around the tubular portion by the first die and the second die clamped in the clamping process with a resin.

2. The insert-molded article manufacturing method according to claim 1, wherein
a plurality of the pressing protrusions are provided at intervals in a circumferential direction of the insertion portion, and
a plurality of locking protrusions are formed by the plurality of pressing protrusions in the clamping process.

3. The insert-molded article manufacturing method according to claim 1, wherein
the pressing protrusion is formed in an annular shape, and
the locking protrusion with an annular shape is formed by the pressing protrusion in the clamping process.

4. The insert-molded article manufacturing method according to claim 1, wherein
the pressing protrusion has a tapered portion that is inclined in a direction in which a diameter expands from a distal end side of the insertion portion, and
the tapered portion abuts on the opening edge and presses the opening edge from the side of the inner peripheral surface to the outer side in the clamping process.

5. The insert-molded article manufacturing method according to claim 1, wherein
the metal collar includes a flange portion formed at an outer periphery of the tubular portion, and
the metal collar is disposed with the flange portion directed to the side of the first die in the insert process.

6. The insert-molded article manufacturing method according to claim 1, wherein
the second die includes an annular collar end surface abutting surface that is formed around a base portion of the insertion portion and a protrusion forming portion that includes a clearance space formed on a radially outer side of the collar end surface abutting surface, and
the collar end surface abutting surface is caused to abut on an end surface of the metal collar, the pressing protrusion presses the opening edge from the side of the inner peripheral surface to the outer side, and an outer periphery of the pressed and deformed metal collar is released to the clearance space of the protrusion forming portion, thereby forming the locking protrusion in the clamping process.

7. The insert-molded article manufacturing method according to claim 2, wherein
the second die includes an annular collar end surface abutting surface that is formed around a base portion of the insertion portion and a protrusion forming portion that includes a clearance space formed on a radially outer side of the collar end surface abutting surface, and
the collar end surface abutting surface is caused to abut on an end surface of the metal collar, the pressing protrusion presses the opening edge from the side of the inner peripheral surface to the outer side, and an outer periphery of the pressed and deformed metal collar is released to the clearance space of the protrusion forming portion, thereby forming the locking protrusion in the clamping process.

8. The insert-molded article manufacturing method according to claim 3, wherein
the second die includes an annular collar end surface abutting surface that is formed around a base portion of the insertion portion and a protrusion forming portion that includes a clearance space formed on a radially outer side of the collar end surface abutting surface, and
the collar end surface abutting surface is caused to abut on an end surface of the metal collar, the pressing protrusion presses the opening edge from the side of the inner peripheral surface to the outer side, and an outer periphery of the pressed and deformed metal collar is released to the clearance space of the protrusion forming portion, thereby forming the locking protrusion in the clamping process.

9. The insert-molded article manufacturing method according to claim 4, wherein
the second die includes an annular collar end surface abutting surface that is formed around a base portion of the insertion portion and a protrusion forming portion that includes a clearance space formed on a radially outer side of the collar end surface abutting surface, and
the collar end surface abutting surface is caused to abut on an end surface of the metal collar, the pressing protrusion presses the opening edge from the side of the inner peripheral surface to the outer side, and an outer periphery of the pressed and deformed metal collar is released to the clearance space of the protrusion forming portion, thereby forming the locking protrusion in the clamping process.

10. The insert-molded article manufacturing method according to claim 5, wherein
the second die includes an annular collar end surface abutting surface that is formed around a base portion of the insertion portion and a protrusion forming portion that includes a clearance space formed on a radially outer side of the collar end surface abutting surface, and
the collar end surface abutting surface is caused to abut on an end surface of the metal collar, the pressing protrusion presses the opening edge from the side of the inner peripheral surface to the outer side, and an outer periphery of the pressed and deformed metal collar is released to the clearance space of the protrusion forming portion, thereby forming the locking protrusion in the clamping process.

11. An insert-molding die comprising:
a first die that includes a metal collar support portion that supports a metal collar including a tubular portion; and
a second die that includes an insertion portion inserted into the tubular portion of the metal collar and includes a pressing protrusion formed to project radially outward from an outer peripheral surface of the insertion portion to press an opening edge of the tubular portion from a side of an inner peripheral surface to an outer side, wherein
the metal collar support portion of the first die includes a collar end surface support surface that abuts on an end surface of the metal collar on one side, and
the second die includes an annular collar end surface abutting surface that is formed around a base portion of the insertion portion to abut on an end surface of the metal collar on the other side and a protrusion forming portion that includes a clearance space formed on a radially outer side of the collar end surface abutting surface and formed to be able to release an outer periphery of the pressed and deformed metal collar.

12. The insert-molding die according to claim 11, wherein
the second die includes a second die body that constitutes a cavity formed around the tubular portion and an insert member that is provided with the insertion portion and is assembled with the second die body.

13. The insert-molding die according to claim 12, wherein
the collar end surface abutting surface is formed over an insert member-side collar end surface abutting surface formed on the insert member and a body-side collar end surface abutting surface formed on the second die body.

14. An insert-molded article comprising:
a metal collar that includes a tubular portion; and
a resin molded portion with which the metal collar is assembled, wherein
the tubular portion is provided with an inclined edge portion that is formed to expand from an inner peripheral surface to an opening edge of the tubular portion and a locking protrusion that projects radially outward from an outer peripheral surface of the tubular portion and bites into and locks the resin molded portion, and
an end surface of the tubular portion to which the opening edge provided with the inclined edge portion is connected is formed in a flat surface shape.
